(19) United States
(12) Patent Application Publication
(10) Pub. No.: US 2004/0133584 A1
(43) Pub. Date: Jul. 8, 2004

(54) Method and system for the management of data

(76) Inventor: Ghislain Lete, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/695,733

(22) Filed: Oct. 28, 2003

(30) Foreign Application Priority Data
Oct. 29, 2002 (FR) 02 13541

(51) Int. Cl. G06F 17/00

(52) U.S. Cl. 707/101

(57) ABSTRACT

Data management is generally carried out by a system comprising a database. The implementation is such databases is cumbersome and entails lengthy periods of time. Furthermore, these are proprietary systems. Such systems are ill suited to open-ended and mobile systems. The present invention proposes an open method of data management that is less cumbersome, and faster to implement. The method comprises:

several data retrieval steps, a subset of data being retrieved at each retrieval step,

a step for the conversion of the subset of retrieved data into a language of interoperability in the form of an elementary file, the conversion step being performed after each retrieval step,

a step for the edition of a general file in a language of interoperability from several elementary files, the general file being designed for an external system capable of processing all the retrieved sets of data transmitted to the general file.

### BACKGROUND OF THE INVENTION

The invention relates to a method and system of data management.

In general, data management is done by a system comprising a database. The implementation of such databases is cumbersome and entails relatively lengthy periods of time (of some weeks or even months). Furthermore, systems using databases are proprietary systems. They therefore generate additional licence-related costs for their users and a cumbersome system of user administration.

Such data management systems are therefore ill suited to open-ended applications. For example, data management for a seismological mission implies that the field data, equipment and staff available for the mission should be taken into account. The terrain might have changed since the last mission, and the equipment and the staff would rarely the same: a new database comprising new data would therefore have be set up with existing systems at each mission.

Now, when a seismological mission of this kind is envisaged, it means that warning signs have appeared and that the mission must be rapidly set up. Data management using present-day systems with databases therefore does not meet the demands of such types of mission, especially in terms of speed of setting up a specialized management system.

Furthermore, since the data collected is of different types, pertaining to terrain, equipment, staff etc., it comes from different sources. The implementation of the database therefore implies cooperation on the part of different sources with the support of a specialist in database implementation. Now, the various sources may be located in different countries when the mission is being prepared. Certain sources are mobiles owing to the type of data that they furnish (for example, field measurements of new lines of levels etc). The fact that the system with database and its data input device are co-located and fixed complicates the process of cooperation.

### SUMMARY OF THE INVENTION

The present invention overcomes these drawbacks by proposing an open-ended method for the management of data that is less cumbersome, swifter and less costly to implement.

An object of the invention is a method of data management comprising:

several data retrieval steps, a subset of data being retrieved at each retrieval step,

a step for the conversion of the subset of retrieved data into a language of interoperability in the form of an elementary file, the conversion step being performed after each retrieval step,

a step for the edition of a general file in a language of interoperability from several elementary files, the general file being designed for an external system capable of processing all the retrieved sets of data transmitted to the general file.

Another object of the invention is a system of data management comprising:

at least one interface enabling the retrieval of data,

at least one converter of retrieved data into a language of interoperability in the form of an elementary file, a converter being connected to each interface,

means for the edition of a general file in a language of interoperability from several elementary files, the means of edition being connected to each of the data converters at least on a one-time basis,

an output designed to be connected to an external system to which the general file will be transmitted.

Furthermore, the invention proposes a data-processing sequence comprising the data management system and an external system comprising an analysis device capable of processing all the sets of retrieved data transmitted into the general file.

### BRIEF DESCRIPTION OF THE DRAWINGS

The characteristics and advantages of the invention shall appear more clearly from the following description, given by way of an example, and from the figures pertaining thereto, of which:

FIG. 1 is a block diagram of an open-ended data management system according to the prior art,

FIG. 2 is a block diagram of an open-ended data management system according to the invention,

FIG. 3a is an exemplary man/machine interface according to the invention, and FIG. 3b is an exemplary machine/machine interface according to the invention,

FIG. 4 illustrates an exemplary formsheet displayed by the interface and an example of the product of the converter according to the invention,

FIG. 5 is a drawing showing the deployment of the data management system according to the invention,

FIG. 6 is a diagram in which the upstream steps of the data management method of the invention are broken down into their separate elements.

### MORE DETAILED DESCRIPTION

The invention is based on the exploitation of the components of e-technology, namely a Web navigator on Intranet/Internet, an HTTP server, Java servlets, HTML formsheets and an XML parser. It does not incorporate the database management system, thus avoid the necessity of incurring the work and costs of such a system.

The simple architecture proposed by the invention remains open to the integration of XML documents produced by other tools or systems, enabling versatile use in XML production and edition. It can be extended to the incorporation of a database for migration to a classic three-tier architecture.

The XML information produced is capable of fully representing the application data for all or part of the system.

XML, which is a language approved by the W3C, is based on a technology favoring interoperability and information sharing. This technology is particularly suited to e-business and to web environments, but its influence is growing in many fields.

There are systems being developed with wider scope. They offer an XML interface rather than a proprietary interface in its format, enabling them to communicate on the basis of a standard with existing or future external systems.

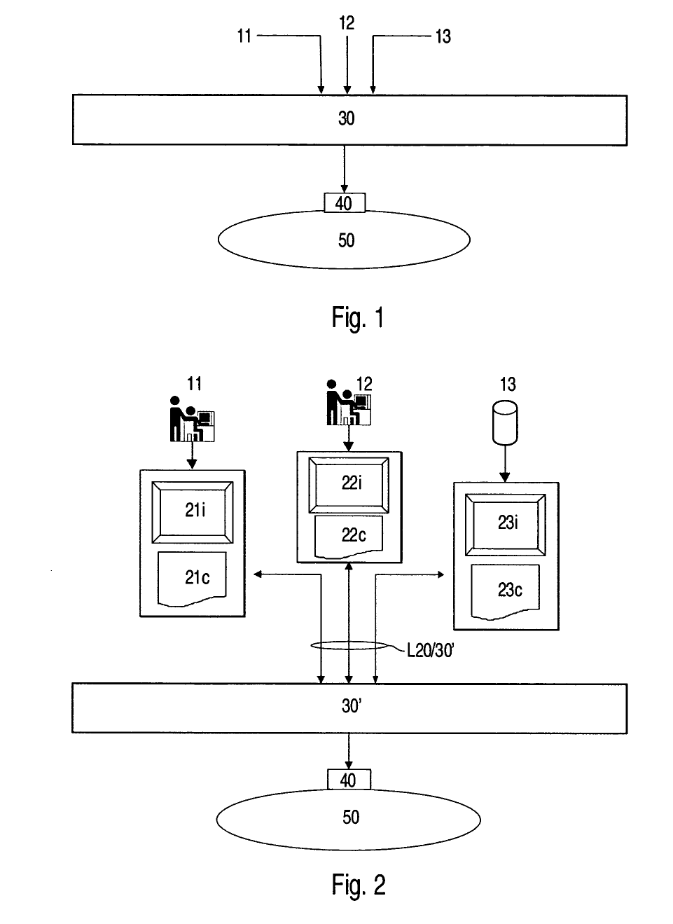

FIG. 1 relates to a block diagram of a prior art open-ended data management system . Several sources 11, 12 and 13 collaborate, each providing a data subset to the edition device 30. In the prior art, data is supplied to an external system 50 via an interface 40 that is an XML interface.

A typical example is the supply, in the form of an XML document, of the input data or programming parameters for an external system 50. This XML interface 40 is an alternative and/or a complement to the implementation of a man/machine interface (MMI) integrated into the external system 50. The collection of input data for the production of an XML document is a peripheral but nevertheless fundamental aspect of the system. This collection may be a cooperative task requiring intervention by qualified individuals from various disciplines, distributed among the different sources 11, 12 and 13 as can be seen in FIG. 1.

Within integrated systems, XML is a supporting technology and remains an abstraction for the final user. XML is also used as an exchange format between persons, organizations and/or systems. In this context, an XML document is handled in the same way as would be the case with a Microsoft Word or Excel document.

Hence, the direct handling of the XML document is clearly possible with the use of a classic text editor (of the Notepad type) or a specialized XML editor (of the XML Notepad type). However, this remains a specialty—based on the exploitation of the pattern or of the DTD associated with the XML document—conducted in isolation by each cooperating source of a subset of input data of the system.

An edition of automated and ergonomic data for each cooperating source brings us to a new system with an adapted presentation interface masking the XML interface and a back-up system which is generally a database. Under these conditions, the activity (which is initially peripheral) induced by the XML interface gives rise to cumbersome and costly developments.

The invention, in its scope, seeks to define a simple data management method: for example by the production of XML documents using formsheets, especially HTML formsheets, presented to the final user in his Web navigator as shown in FIG. 2.

The different sources 11, 12, 13 have access to an interface, respectively 21i, 22i and 23i, enabling the retrieval of the data. The sources 11, 12, 13 may have access either to a single interface 20i, or each to its own interface 21i, 22i and 23i as shown in FIG. 2, or each to an interface of its own for certain sources and all to a common interface for other sources.

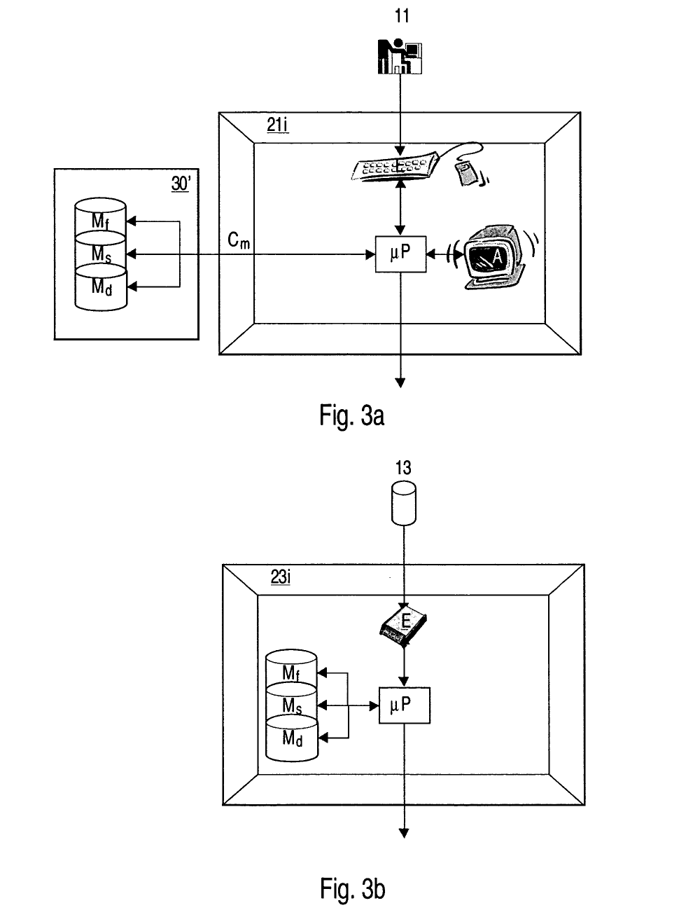

FIGS. 3a and 3b show two exemplary interfaces 20i, 21i, 22i, 23i. The interfaces 20i, 21i, 22i and 23i may comprise an introduction device E. This introduction device E enables data to be either introduced by a user 11 or 12, or received from a source device 13.

Thus the introduction device E for the user 11 may be, for example, a keyboard, a mouse, a touchscreen, a voice recognition device etc. as can be seen in FIG. 3a. The introduction device E for the source device 13 may, for its part, be a modem for a cable link, a radio, satellite, infrared or other receiver as can be seen in FIG. 3b.

The interfaces 20i, 21i, 22i and 23i may be connected by the output Cₘ to storage means M (FIG. 3a) or they may comprise (FIG. 3b) these storage means M. The storage means M may carry out storage as follows, in particular as follows: M_{d} may store several use rights, Mₛ may store data on one or more users and/or source devices and the associated use rights, M_{f} may store several data entry formsheets 20i(1) and 20i(2), and the associated use rights.

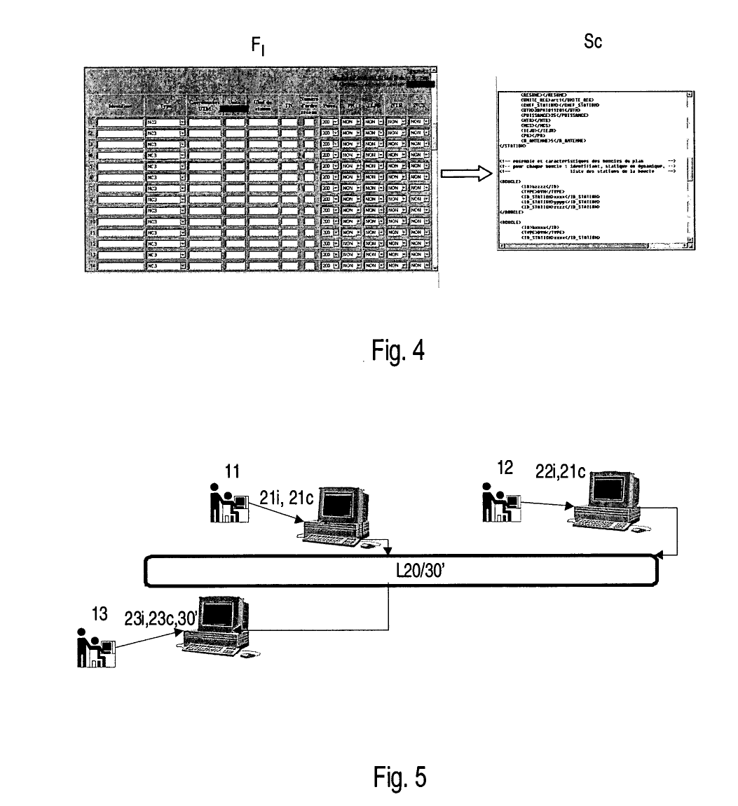

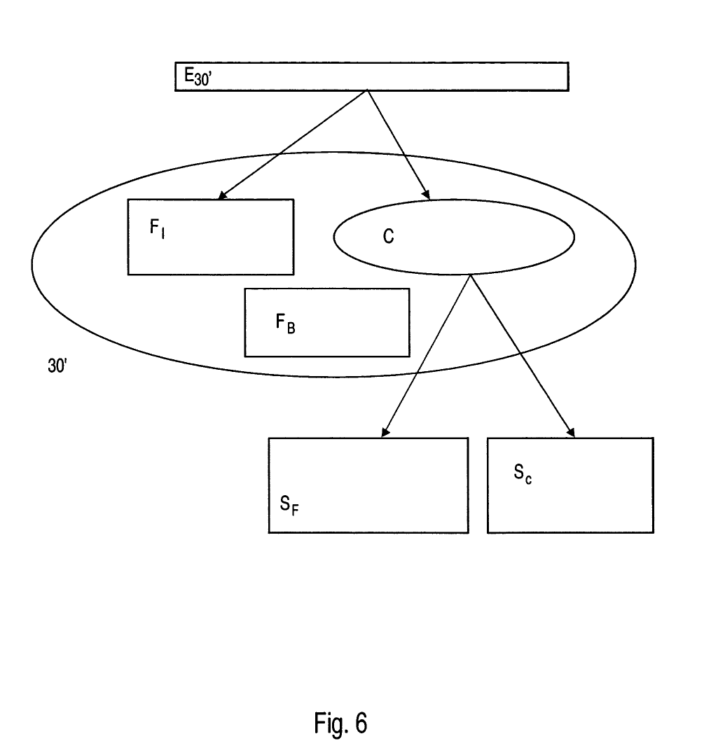

In the case of a man/machine interface 21i, as shown in the FIG. 3a, the interface 21i may comprise a display device A. This display device A can be used to guide the user 11 to enter data through the entry device E. It may also be a monitor displaying one of the data entry formsheets Fₗ (see FIG. 4) stored in the storage means M.

Furthermore, the interfaces 20i, 21i, 22i and 23i may comprise means μP to control the display and entry devices and storage means which, as a function of the use rights associated with the user of the source device operating on the system, generate the formsheet having the same associated use rights in which the data are retrieved.

Each interface 20i, 21i, 22i, 23i is connected to a converter 20c, 21c, 22c, 23c. The converter 20c, 21c, 22c, 23c transcribes the data retrieved by the interface 20i, 21i, 22i, 23i in a language of interoperability, especially XML, in the formsheet of an elementary file (like the one presented in FIG. 4).

The elementary files thus produced are transmitted to edition means 30′. The edition means are therefore connected to each of the data converters at least at specific points in time or even permanently, either by cable links (Internet or Intranet, telephone etc), or by radio links (GSM, GPRS, UMTS etc), or by satellite links, or by infrared links (especially between two laptops) etc. From several elementary files, the edition means produce a general file in a language of interoperability.

Thus, the interface 20i, 21i, 22i, 23i and the associated converters 20c, 21c, 22c, 23c may be either co-located or de-located. Furthermore, the means 30′ for editing a general file may be de-located relative to the interfaces 20i, 21i, 22i, 23i and to the converters 20c, 21c, 22c, 23c. The interface 21i, 22i or the interface-converter set 21i-21c, 22i-22c and the edition means 30′ may be portable, thus ensuring the mobility of the user 11, 12.

An output of the data management system enables the transmission of the general file thus obtained to an external system. Similarly, the link to the external system for which the general file is designed may be set up at specific points in time or it may be permanent. It may be a cable link or a wave link (radio, infrared, satellite or the like).

The data management system may also comprise an input connected to the means 30′ for the editing of a general file and designed to be connected to an elaborate source device 14 (not shown), the elaborate source device transmitting at least one elementary file in a language of interoperability to the means 30′ for the edition of a general file through this input.

The architecture of the data management system can be subdivided into at least the following two variants:

The first variant uses HTML as a hinge format for the display and persistence of the information. This is the simpler of the two variants presented. It does not necessitate any XML analyzer and associated developments. Despite distribution around a network on the low-priority clients, this architecture must be classified under the “one-tier” category. The process associated with the development of such an application is of the RAD (Rapid Application Development) type, namely an application whose development is swift in the sense commonly associated with “Quick & Dirty”.

This approach remains viable for a limited number of users, with a relatively simple data model. Tools from the XML world (namely XSL stylesheets and XSLT transformers) are used to ensure and automate the developments of the XML production system. This variant is particularly adapted to making models of the data management system to be set up.

The second variant uses HTML as an information presentation format and XML as an information persistence format. This uncoupling, provided by an XML analyzer, enables the architecture to be classified in the “two-tier” category. The implementation of this approach remains simple; the XML analysis represents the excess cost relative to the first variant. This variant enables the development of complete, open-ended and lasting applications, in associating the short-term effectiveness of a RAD type process and the quality criteria indispensable to the applications of the services and industry sectors.

An exemplary implementation of the data management system is shown schematically in FIG. 4. This is a case with three users 11, 12, 13 on three workstations (customer units). Each of the three units has an interface 21i, 22i, 23i and a converter 21c, 22c, 23c. One of the stations hosts the edition means 30′, for example in the form of a cooperative edition software designed according to the principles of architecture (this customer station may also be a server station). This is a preferred use of the principle. Other cases of implementation possible include restriction to a single station (a single user who is both customer and server) and a dedicated server station (no user associated with a server station which only hosts the edition software). The case of restriction to one station enables the implementation of the principle and of the architecture associated with “stand-alone” applications.

An example of characteristics of deployment of the data management system is given here below:

At customer stations, only the presence of the storage means and of the interface control means 21i, 22i, 23i is required. In particular, when the interface comprises the use of a formsheet in the HTML format, the means may include a navigator (for example Netscape or Microsoft Explorer). The user gets connected to the URL of the HTTP server hosting the converter 21c, 22c, 23c, for example an XML edition software.

On the server station: the means 30′ for the edition of a general file (for example a cooperative edition software) are installed. The edition means 30′ comprise:

Communications means using the L20/30′ link with the interfaces 21i, 22i, 23i and converters 21c, 221c, 23c (for example a middleware part comprising the installation of an HTTP server comprising the JAVA servlets, especially an APACHE server or a TOMCAT low-level server).

Storage means M enabling especially presentation to the sources 11, 12, 13. When the formsheets Fₗ and F_{R} users are HTML formsheets, they enable presentation of the HTML files of the application (for example, the presentation page F_{R}, online assistance, the formsheets Fₗ for the representation of the XML documents to be produced). Control and/or presentation applets may be associated with the HTML files.

Control means for example in the form of a server application part, enabling the installation of the JAVA classes of the application (servlets classes, analyzer classes and XML analysis classes for the second variants, classes of persistence)

To simplify the text of the presentation of the principle, the term “JAVA application” is used here below to designate the server part as a whole.

The full XML document to be produced is structured in subsets. Each subset is assigned to a source 11, 12, 13 responsible for preparing the XML subset corresponding to each subset. An HTML formsheet Fₗ, corresponding to each subset, is created. This formsheet Fₗ is the representation, in the navigator, of the source 11, 12, 13 of the XML document part that this source 1, 1, 12, 13 must produce. Each formsheet Fₗ forms part of the edition means 30′. In the present example, it forms part of the edition software installed on the server.

Each formsheet Fₗ, once provided with information by the source 11, 12, 13, is stored in the storage means M of the edition means 30′ (backed up in the form of a file on the server, for example) enabling it to be re-edited by the source 11, 12, 13. The backup is provided by the JAVA application.

In a first variant, HTML is the hinge format of the architecture. The file is in the rough HTML format (the filled-in formsheet is saved). Re-edition by the source 11, 12, 13 is ensured by a hyperlink on the saved HTML file. In a second variant, the file is in the XML format. The data of the HTML formsheet received by the JAVA application is converted into XML. The re-edition by the source is ensured by the XML analyzer of the JAVA application: the formsheet is generated and its data is extracted from the XML file.

The production of the XML is done by the converter 21c, 22c, 23c, for example by generation of the XML text in the navigator (“text/plain” format) from information of the filled-in formsheet. The generation is done by the JAVA application. The XML text is then available at the station of the source 11, 12, 13 which can record it locally and thus transfer it. This method enables the system to produce files on the customer station. This is normally impossible from an application launched in a navigator (in the “sand-box” mode of operation).

The production of the full XML document is done by the choice of the source 13 (called the administrator) of the subsets to be merged. This choice may be given by the administrator-source 13 listing the documents available for each source 11, 12, 13 and enabling it to select one or more of them for each source 11, 12, 13. It is these selections that are merged.

In the case of the first variant, there is a preliminary presentation to the administrator-source of the accumulated information:

by the creation of a general formsheet F_{G} formed by the combination of the formsheets corresponding to each subset. This merger is based on the markings made during the saving of each formsheet by the JAVA application, enabling the adjustment and generation of the result formsheet (to introduce a specific header in particular).

by the generation of the XML text in the navigator from information of the filled-in general formsheet (in the same way as for an elementary formsheet).

In the case of the second variant, the preliminary presentation of the accumulated information to the user is not necessary. The full XML production is direct: by the generation of the XML text in the navigator from the merger of each elementary XML file saved (no XML analysis).

For the first variant, HTML is used as a hinge format of the XML production: this is a merger of the display and persistence functions, making the data management process simple and light. It is not necessary to have recourse to the service of the database management system and an associated database, or an XML analyzer to reconstitute the information representation formsheet.

For the second variant, the XML production relies on a native XML format, and HTML is restricted to display in the navigator. This approach has the advantage of the separation between essentials (XML) and the formsheet (HTML) and of being more robust relative to variations of presentation in the navigator.

The main steps of the data management method are:

several steps of data retrieval, a subset of data being retrieved at each retrieval step,

a step for the conversion of the subset of retrieved data into a language of interoperability in the form of an elementary file, the conversion step being performed after each retrieval step,

a step for the edition of a general file in a language of interoperability from several elementary files, the general file being designed for an external system capable of processing all the sets of retrieved data transmitted in the general file.

The pieces of data are introduced by a source that is a user or transmitted by a source device. This introduction of transmission of the data formsheets forms part of the data retrieval step. The data may be retrieved in a predetermined form Fₗ as a function of the type of data to be retrieved. In this case, when the data is transmitted by a source device, the transmitted data will have been formatted according to the retrieval formsheet before the data is transmitted.

The elementary file may be a sub-sequence of commands, and the general file may be a sequence of commands, these commands being designed for the parametrization and/or the control of external electronic devices. The language of interoperability used may be the XML language or one of its variants, or associated with the JAVA language.

The characteristics of the edition means 30′, when these means comprise a cooperative edition software based on servlets, are shown schematically with their environment in FIG. 5. The structure of the XML documents to be produced (DTD—Document Type Definition or diagram) is given to the edition means 30′. From this structure, a definition is made of the formsheets, for example HTML formsheets, of representation Fₗ and the control means C, especially in the form of JAVA applications (servlets, XML parser, classes of persistence), comprising the converter 21c, 22c, 23c. The edition means also comprise (welcome), applet assistance, JAVA and JavaScript formsheets F_{B} which can be used, for example, to identify the source 11, 12 or 13. The JAVA C application enables the backup of the HTML or XML files S_{F} corresponding to the filled-in formsheet Fₗ, and also of the conversion of the filled-in formsheet Fₗ into an XML file S_{C}.

The following are the main functions of the data management method implemented in this example:

a) The retrieval of the data in the fields of an elementary formsheet Fₗ at the level of the interface 21i, 22i, 23i.

b) The conversion of the filled-in elementary formsheet Fₗ into a file S_{c} (HTML for the first variant and XML for the second variant) by the converter 21c, 22c, 23c and the saving of this file (either at the converter 21c, 22c, 23c, or at the edition means 30′).

c) The generation of an HTML file corresponding to the list of the elementary formsheets already filled in by the user (file of links for the first variant, and list of formsheets for the second variant) by the edition means 30′.

d) The generation and sending to the navigator of the XML text corresponding to the filled-in elementary formsheet.

e) The retrieval of the source-administrator choice by an interface 21i, 22i, 23i of the elements S_{C} to be merged, and the generation:

for the first variant, of an HTML file corresponding to the combination of the filled-in elementary formsheets. The functions 1 and 4 are then applicable to the general formsheet.

For the second variant, of the full XML result by the edition means 30′.

by the edition means 30′.

The present invention therefore defines a method and a system of data management enabling the edition of the data in a language of interoperability. One of the examples illustrating the invention consists of a software method and architecture for the designing, development and implementation of a simple and uncumbersome method for the production and edition of documents in the XML format in a cooperative and distributed environment.

This software architecture for the production of XML documents has the following characteristics:

light architecture (with a simplified effort of development and implementation)

cooperative architecture enabling the concurrent preparation of parts of XML documents and its merger into result documents. The result XML format is directly available for each cooperating entity.

Architecture distributed around a multi-hub intranet network

Architecture open to XML documents generated by external systems

The invention also relates to a data-processing chain comprising the data management system described and an external system comprising an analysis device capable of processing all the sets of retrieved data transmitted in the general file. The analysis device may be capable of generating a file in a language known as a language of interoperability comprising commands for end-of-the-line devices corresponding to the commands and/or parameters of elementary files which may or may not be modified as a function of the other data contained in the general file.

What is claimed is:

1. A method for the management of data, comprising the steps of:
several data retrieval steps, a subset of data being retrieved at each retrieval step;
a step for the conversion of the subset of retrieved data into a language of interoperability in the form of an elementary file, the conversion step being performed after each retrieval step;
a step for the edition of a general file in a language of interoperability from several elementary files, the general file being designed for an external system capable of processing all the retrieved sets of data transmitted to the general file.

2. The method for the management of data according to claim 1, wherein the elementary file is a sub-sequence of commands, and the general file is a sequence of commands, these commands being designed for the parametrization and/or control of external electronic devices.

3. The method for the management of data according to claim 1 wherein the data retrieval step comprises the entry of data by a user or the transmission of the data by a source device.

4. The method for the management of data according to claim 1 wherein, during the data retrieval step, the data is retrieved in a formsheet predetermined as a function of the type of data to be retrieved.

5. The method for the management of data according to claim 3, wherein the retrieval step comprises the formatting, by the source device, of the data according to the retrieval formsheet before the data is transmitted.

6. The method for the management of data according to claim 1 wherein the language of interoperability is XML or one of its variants, or associated with the Java language.

7. A system for the management of data, comprising:
an interface enabling the retrieval of data;
at least one converter of retrieved data into a language of interoperability in the form of an elementary file, a converter being connected to each interface;
means for the edition of a general file in a language of interoperability from several elementary files, the means of edition being connected to each of the data converters at least on at specific points in time; and
an output designed to be connected to an external system to which the general file will be transmitted.

8. The system for the management of data according to the above claim, implementing the method of data management according to claim 1.

9. The system for the management of data according to claim 7, comprising means of storage in which there are stored several use rights, one or more users and/or source devices and the associated use rights, several data entry formsheets and the associated use rights.

10. The system for the management of data according to claim 8, comprising means of storage in which there are stored several use rights, one or more users and/or source devices and the associated use rights, several data entry formsheets and the associated use rights.

11. The system for the management of data according to claim 9, wherein either the interface or the edition means comprise storage means.

12. The system for the management of data according to claim 10, wherein either the interface or the edition means comprise storage means.

13. The system for the management of data according to claim 7, wherein the interface comprises:
an entry device enabling data to be introduced by a user or transmitted by a source device, and/or a display device; and
means for the control of the display and entry devices and storage means displaying, as a function of the use rights associated with the user or with the source device working on the system, the formsheet having the same associated use rights in which the data is retrieved.

14. The system for the management of data according to claim 11, wherein the interface comprises:
an entry device enabling data to be introduced by a user or transmitted by a source device, and/or a display device; and
means for the control of the display and entry devices and storage means displaying, as a function of the use rights associated with the user or with the source device working on the system, the formsheet having the same associated use rights in which the data is retrieved.

15. The system for the management of data according to claim 7, wherein the interface and the converter are co-located and/or portable, and/or the means for the edition of a general file are de-located relative to the interfaces and to the converters and/or are portable.

16. The system for the management of data according to claim 11, wherein the interface and the converter are co-located and/or portable, and/or the means for the edition of a general file are de-located relative to the interfaces and to the converters and/or are portable.

17. The system for the management of data according to claim 7, comprising at least one input connected to the means for the edition of a general file and designed to be connected to an elaborate source device, the elaborate source device transmitting at least one elementary file in an interoperability language to the means of edition of a general file through this input.

18. The system for the management of data according to claim 12, comprising, at least one input connected to the means for the edition of a general file and designed to be connected to an elaborate source device, the elaborate source device transmitting at least one elementary file in an interoperability language to the means of edition of a general file through this input.

19. The data-processing chain comprising a system for the management of data according to claim 7, comprising an external system comprising an analysis device capable of processing all the sets of retrieved data transmitted in the general file.

20. The data-processing chain according to claim 19, wherein the analysis device is capable of generating a file in an interoperability language comprising commands for final devices corresponding to the commands and/or parameters of the elementary files, modified or not modified as a function of the other data contained in the general file.
